(19) United States
(12) Patent Application Publication
(10) Pub. No.: US 2020/0117468 A1
(43) Pub. Date: Apr. 16, 2020

(54) SHUTDOWN SEQUENCE OF THIN CLIENTS

(71) Applicant: HEWLETT-PACKARD DEVELOPMENT COMPANY, L.P., Spring, TX (US)

(72) Inventors: Tom Flynn, Houston, TX (US); Matthieu Clemenceau, Houston, TX (US)

(21) Appl. No.: 16/481,888

(22) PCT Filed: Jul. 3, 2017
(86) PCT No.: PCT/US2017/040592

§ 371 Date: Jul. 30, 2019

(51) Int. Cl. G06F 9/4401; G06F 11/30; G06F 13/42

(52) U.S. Cl. CPC G06F 9/442; G06F 2213/0042; G06F 13/4282; G06F 11/3062

(57) ABSTRACT

Examples disclosed herein relate to a thin client. A thin client device can include a power receiver and a shutdown power source sized to store an amount of power for a shutdown sequence of the thin client. The thin client may include a basic input output system (BIOS) to initialize a shutdown sequence powered by the shutdown power source in response to detection of a power loss condition at the power receiver.

### BACKGROUND

Thin clients are connected to another computer such as a server. Thin clients function in tandem with a connected computer that fulfills some of the computational roles for the thin client. Power is provided to the thin client in order for the thin client to display data, host virtualized applications, a virtual desktop, and receive input from a user. User input and manipulations that occur at the thin client may be sent to another computer for long term storage or processing.

### DESCRIPTION OF THE DRAWINGS

Certain examples are described in the following detailed description and in reference to the drawings, in which:

FIG. 1 is a diagram of an example thin client device;

FIG. 2 is a diagram of an example system for a thin client with a shutdown power source connected to a display;

FIG. 3 is a diagram of an example thin client mounting and display;

FIG. 4 is a block diagram of an example thin client system;

FIG. 5 is a flowchart of an example method for a thin client; and

FIG. 6 is a block diagram of an example tangible, non-transitory, computer-readable medium including instructions to direct a processor of a thin client.

### DETAILED DESCRIPTION

The present disclosure relates to a thin client with a shutdown power source. As discussed herein, a thin client may function in tandem with a connected computer that provides services, such as storage, power, and the like, to the thin client. The thin client may have a local file system. A power supply may provide power to the thin client in order for the thin client to display data, host applications, and receive input from a user. A display may connect to a thin client and display the data of the thin client. The thin client may draw power from the connection between the thin client and the display.

The thin client may lose power during operation due to an inadvertent occurrence, such as a power outage, or a planned occurrence, such as a supply of power for a thin client switching off. The power losses can result in the shutdown of a thin client file system or operating system prior to proper handling of the active data of the thin client. A power loss can stop a system before a shutdown sequence can complete, resulting in loss or corruption of data in the thin client file system. For example, data or active system states of a thin client can be lost if not properly stored, complied, check-pointed, or output as appropriate.

As a thin client may include a basic input/output system (BIOS), an operating system, a file system, or combinations thereof, the ability to detect and respond to a power loss event can be incorporated into these systems. As a result, the thin client may initialize a shutdown sequence, utilizing an internal power source for a duration of the shutdown sequence to avoid data loss and file system corruption.

Further, a display connected to a thin client may provide power to the thin client until the display is switched off by a user. As multiple manufacturers can provide displays that function with a connected thin client, it may be difficult to provide a general power off signal that may be sent to a thin client to indicate a power off occurrence. Accordingly, the thin client may respond to a manual shutdown of power in the same way as an inadvertent loss of power. As a result of the power loss detection by the thin client, the connected device and the thin client can be powered off using the same button used to power off the connected device.

In both cases, the thin client can detect a loss of power at a thin client power receiver. The thin client may include a shutdown power source to provide power in response to a power loss condition. The shutdown power source of the thin client can provide power to the thin client for a time duration sufficient to complete a thin client shutdown sequence. As described herein, the thin client may perform a power loss detection without receiving a data signal from another device that the power loss is going to occur. Thus, the thin client may respond to a power loss event independent of the manufacturer for a connected device.

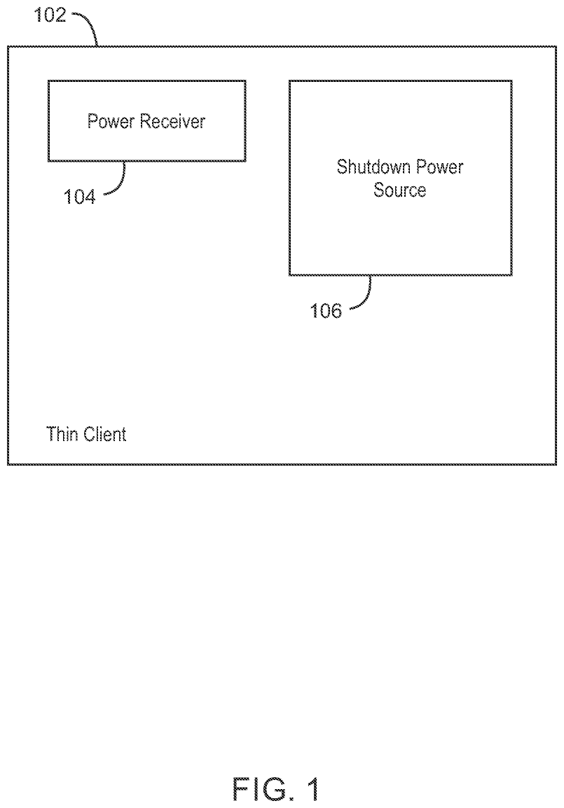

FIG. 1 is a block diagram of an example thin client 102. The thin client 102 may be capable of multi-protocol client-server communication, and may include an operating system. The thin client 102 may be a zero client, which is a variant type of thin client that can function without a full operating system, instead using firmware, such as a BIOS, that initializes and performs network communication. The zero client variant may also use firmware to decode display information received from the server and send local input back to a host. The thin client 102 can be a web client, which is a variant type of thin client that relies on web applications to provide general-purpose computing functionality and store files remotely. The web client variant of a thin client can also store files locally.

The thin client 102 may include a power receiver 104. The power receiver 104 may be associated with a Universal Serial Bus (USB) port, such as a USB Type C port operating under the USB 3.0 specification, among others. The power receiver 104 can receive power from a physical connection, such as the USB Type C port, or through a wireless power transfer using standards such as Qi developed by Wireless Power Consortium and Rezence developed by Alliance for Wireless Power, among others. The USB Type C port, or other physical connection, may also provide a data channel in addition to receiving power. The thin client 102 may communicate data through the data channel or through a wireless data communication protocol such as Wi-Fi, Bluetooth, Bluetooth low energy, NFC, or the Wireless USB standard, among others.

As described herein, the thin client 102 may include a Basic Input Output System (BIOS) that can detect power received at a power receiver 104. In the event of power loss at the power receiver 104, the BIOS of the thin client 102 can detect a power loss condition. For example, the BIOS may detect a power loss condition from a USB Type C power receiver 104. The power loss may include a complete loss of power to the power receiver 104.

Further, the detection of a power loss may include a determination that an insufficient amount of power is being supplied to a power receiver 104. The sufficiency of power for a thin client can be determined based on the power needs of the thin client during operation, for example, as calculated by adding together the power consumption of hardware components in the thin client. The power needs of a thin client may be calculated by identifying a full power output capability of the power receiver 104 of the thin client 102.

In response to a power receiver 104 either detecting a complete loss of power or receiving insufficient power for the thin client, the BIOS of the thin client may provide a notification that power loss event is occurring. The notification may take the form of a force shutdown command. The force shutdown command may cause the thin client 102 to activate a shutdown power source 106, and initiate the storage of data.

The shutdown power source 106 may include a battery, a capacitor, or a hybrid-supercapacitor, which can provide power to the thin client 102. The shutdown power source 106 may be an individual cell or an array of rechargeable lithium-ion cells, nickel-cadmium cells, or nickel-metal hydride cells, among others. For example, the shutdown power source 106 may include an individual or array of non-rechargeable lithium-ion batteries. The shutdown power source 106 may include power film capacitors, electrolytic capacitors, ceramic capacitors, or super capacitors such as double-layer capacitors, pseudocapacitors, or hybrid capacitors.

The shutdown power source 106 may be charged using a charging circuit supplying constant direct current (DC) or pulsed DC. For example, the shutdown power source 106 may be charged using an inductive charger, a motion-powered charger, a pulse charger, a solar charger, trickle or low current charger, or a USB based charger, among others.

As described herein, upon detection of power loss event, the shutdown power source 106 is switched to an active status to provide power to the thin client 102. In an active status, the shutdown power source 106 may provide power to the thin client independent of a display device or external power supply.

Upon detection of a power loss event, the thin client 102 can commence a shutdown sequence. For example, the BIOS of the thin client 102 may issue a force shutdown command from the BIOS to the software and hardware components in the thin client without engaging the operating system. Alternatively, the BIOS of the thin client can request the operating system of the thin client invoke an operating system-based shutdown command.

A number of other variations may be used to control the powering off sequence. For example, the shutdown sequence may be commenced in response to the activation of the shutdown power source 106. The shutdown sequence may include an associated or estimated time duration. The BIOS may invoke a power-off button event, where the power-off button event can be a process activated by a power button of the thin client 102. The thin client 102 may not include a power button and a power-off button event may be issued by the BIOS. The power-off button event may be simulated in order to initiate a shutdown sequence for the data of the thin client even if no physical button, switch, toggle, or the like, is present.

Upon detection of a power loss event, the thin client 102 may delay the initializing of a shutdown sequence for a predetermined time. The delay of a shutdown sequence initialization may ensure that a shutdown sequence is not triggered during short term interruptions of power loss. For example, a power supply may be accidentally bumped or unplugged leading to a brief power loss. These brief interruptions may quickly end with power being restored. The thin client can include a shutdown power supply sized to accommodate the power interruption delay. This may prevent an unnecessary shutdown.

The size of the shutdown power source 106 refers to the power capacity of the shutdown power source 106. The shutdown power source 106 may be sized to provide power for the time duration of a shutdown sequence on a thin client. For example, the shutdown power source 106 can be sized to match a power demand equal or exceeding the power consumption of the thin client 102 over the duration of a shutdown sequence. The power consumption of the thin client 102 can be estimated or calculated prior to a power loss event.

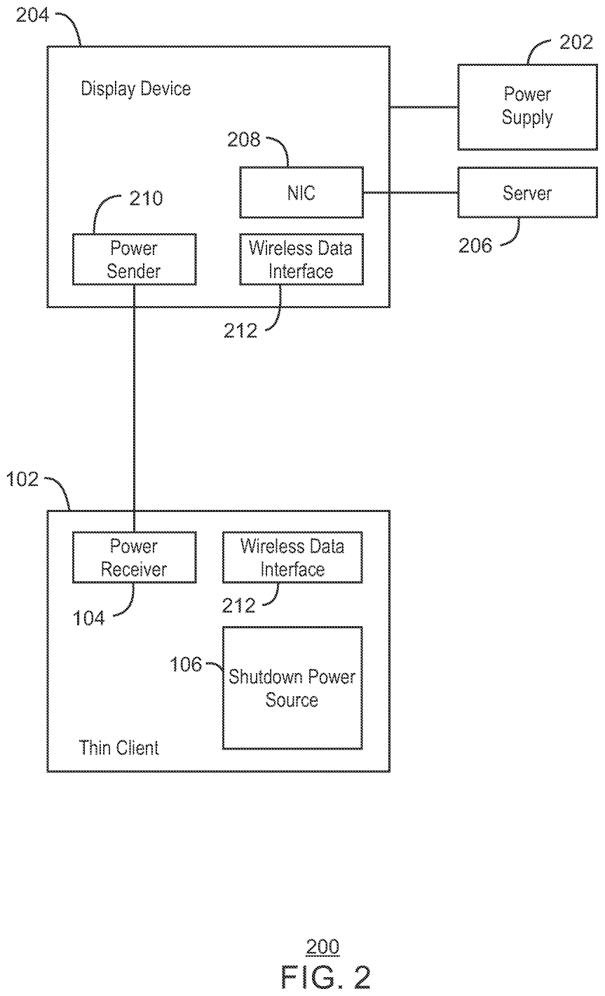

FIG. 2 is a block diagram of an example system 200 for a thin client 102 with a shutdown power source 106 connected to a display. Like numbered items are as described with respect to FIG. 1.

In this example, the system 200 can include a power supply 202 connected to a display device 204. The power supply 202 can be an alternating current (AC) power supply or a direct current (DC) power supply. The power supply 202 can connect to the display device 204 physically or wirelessly. The display device 204 may be a digital display screen such as a computer monitor, television screen, tablet, display surface, or a projector projecting an image, among others.

The system 200 may include a server 206 to provide data for a thin client 102. For example, the server 206 may be a computer, located locally or remotely, that provides functionality for other programs or devices including programs and services for the thin client 102. As discussed, the thin client 102 may connect to the server 206 for data requisition, data storage, data processing, among other actions. The server 206 may connect to the thin client 102 via a display device 204 that is coupled to the server 206 over a network by a network interface controller (NIC) 208. The network can be an enterprise server network, a storage area network (SAN), a local area network (LAN), a wide-area network (WAN), or the Internet, for example. Applications and other data for the thin client 102, including an operating system for a zero client, can be accessed from the server, for example, through the NIC 208 in the display device 204.

The display device 204 can include a power sender 210 to provide power to the power receiver 104 of the thin client 102. The thin client 102 may draw power from the display device 204 via the power sender 210. The power sender 210 may provide power to the power receiver 104. The shutdown power source 106 of the thin client 102 can be charged or recharged by the power drawn from the display device 204. The shutdown power source 106 may charge or recharge in in response to a system start detection. A system start detection can refer to a power-on event that is detected by the thin client 102 when power is received at the power receiver 104. A system start detection may refer to a power on event that issues a data notification from the display device 204 to the thin client 102.

The display device 204 may include a wireless data interface 212 to transmit data from the display device 204 to the thin client 201. The thin client 102 may receive data at a wireless data interface 212. The wireless communication may follow a wireless communications protocol such as the Qi protocol developed by Wireless Power Consortium and Rezence developed by the Alliance for Wireless Power, among others.

As discussed with respect to FIG. 1, the power receiver 104 can detect a power off event in response to a drop or failure in power from the power sender 210 of the display device 204. The thin client 102 can initiate a shutdown sequence as a result of the detection of the power loss. The initiation of a shutdown sequence for a thin client 102 may not rely on compatible communication or feature support for indicating a power off event from the display. Use of the shutdown power source 106 by the thin client 102 when a power loss event is detected allows the thin client 102 to safely shut down.

A BIOS of the thin client 102 may detect a power loss condition on a power receiver 104, such as a USB Type C power receive module. Upon detection of the power loss event, the shutdown power source 106 may switch to an active status. In response to either the detection of the power loss event or the active status of the shutdown power source 106, a force shutdown command may be issued by the operating system of the thin client 102. A thin client 102 can issue a command for a graceful shutdown or a simulated power-off button event. A simulated power-off button event can include a shutdown mode, a standby mode, or low power mode, among others.

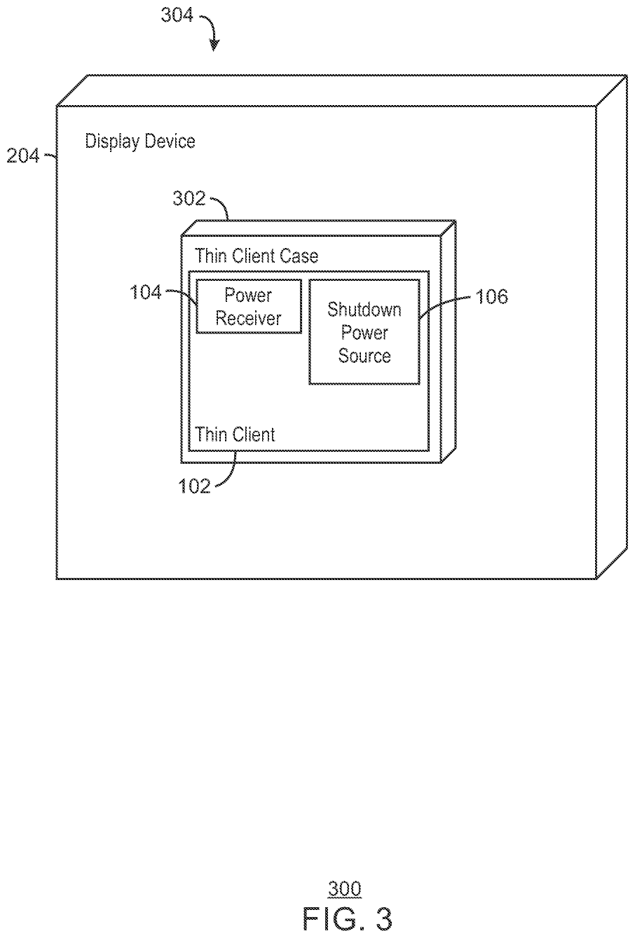

FIG. 3 is a diagram of an example 300 of the mounting of a thin client 102 to a display device 204. Like numbered items are as described in FIG. 1 and FIG. 2. The items of FIG. 3 are not shown to indicate exact placement or dimensions but are provided to illustrative purposes.

The thin client 102 may be enclosed in a thin client case 302. The thin client case 302 may be mounted to the display device 204. For example, the thin client 102 or thin client case 302 can be mounted to the back of the display device 204 with a front display side 304 opposite the mounted location.

Mounting the thin client 102 on the back of the display device 204, or on the side of the display device 204, may avoid obstruction of the front display side 304 of the display device 204, but may also make it difficult for a user to physically reach the thin client 102. Although the thin client 102 may include an input device, such as a power button, if the thin client 102 is mounted on the back of a display, a user may have difficulty reaching the power button. Using the present techniques, a thin client 102 may detect a power loss event without a user physically accessing or manipulating the thin client 102. The detection of the power off event and the shutdown power source 106 allows the thin client to be mounted in a location and provide on/off functions without being physically accessible to a user of the display device 204.

The thin client case 302 may include a single port of the case that may be used for data and power channels to connect the thin client to the display device 204. In other examples, the sole port of the case may be used for a power connector connecting the thin client 102 to a power supply, with a wireless communications channel for data. In some examples, the thin client case 302 may have no ports, with both power and data transmitted to and from the thin client wirelessly. The thin client case 302 can encase the thin client 102 where the sole ports of the case are for a data channel and a separate power connector. In one example, the thin client case 302 may have a single USB type C port for both data and power.

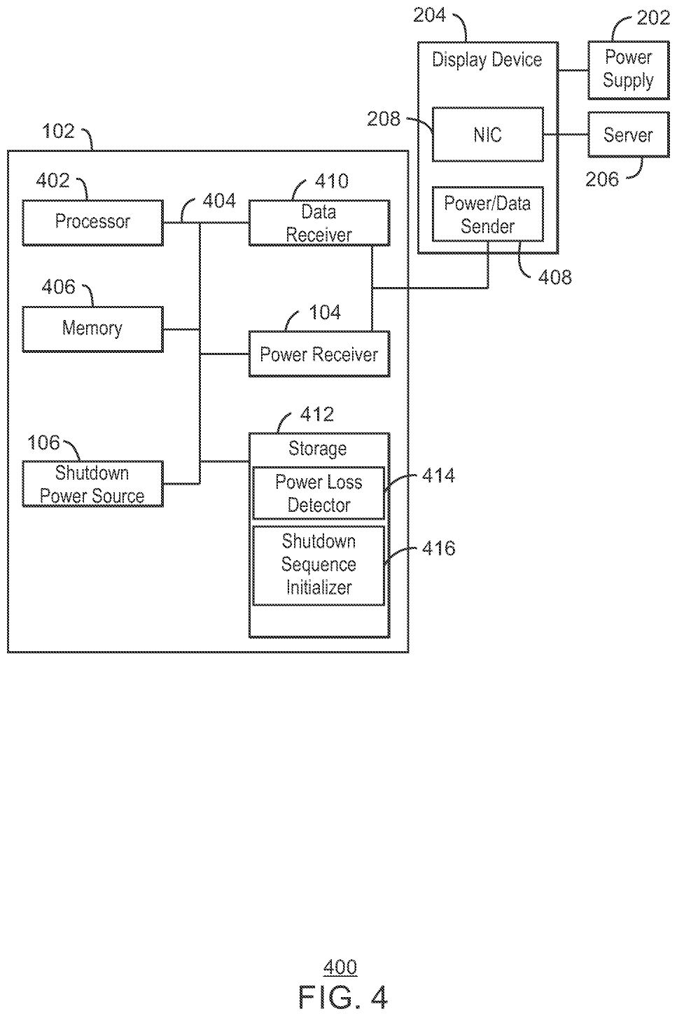

FIG. 4 is a block diagram of an example thin client system 400. Like numbered items are as describe above with respect for FIGS. 1 and 2. The thin client 102 may include at least one processor 402. The processor can be a single core processor, a multicore processor, a processor cluster, and the like. The processor 402 can be coupled to other units through a bus 404. The bus 404 can include peripheral component interconnect (PCI) or peripheral component interconnect express (PCIe) interconnects, peripheral component interconnect extended (PCIx), or any number of other suitable technologies for transmitting information. The bus 404 may include power lines as well as data lines. In an example the bus 404 may include a power line that can carry a +3.3, +5, or a +12 voltage, among others.

The thin client 102 can be linked through the bus 404 to a memory 406. The system memory 406 can include random access memory (RAM), including volatile memory such as static random-access memory (SRAM) and dynamic random-access memory (DRAM). The system memory 406 can also include directly addressable non-volatile memory, such as resistive random-access memory (RRAM), phase-change memory (PCRAM), Memristor, Magnetoresistive random-access memory, (MRAM), Spin-transfer torque Random Access Memory (STTRAM), and any other suitable memory that can be used to provide computers with persistent memory. A memory can be used to implement persistent memory if it can be directly addressed by the processor at a byte or word granularity and has non-volatile properties.

The processor 402 of the thin client system 400 may be connected to a display device 204 which is in turn connected to a power supply 202. As discussed, the display device 204 may draw power from the power supply 202. The power supply may also include an alternating current (AC) connection to an electric power grid. In another example, the power supply 202 may not include a connection to an electric grid. The power supply 202 may be a battery, such as a lithium-ion battery or another rechargeable battery, or a capacitor, among others.

The power supply 202 may provide power to the display device 204. The display device can be a standalone screen or an integrated display for a laptop, tablet, television, or digital signage. The display device 204 can include a power/data sender 408. The display device may receive data from a desktop computer, a business server, and the like.

The power/data sender 408 may transfer power and data received at the display device to the thin client 102. The power/data sender 408 may send power and data to the thin client 102 through a single line or multiple lines. The data from the power/data sender 408 may be received at a data receiver 410. The power from the power/data sender 408 may be received at a power receiver 104 of the thin client. The data receiver 410 and the power receiver 104 may be the same component depending on the standard used for transmitting the power and data. The power and data may be transmitted through a USB type connection and wire including a USB type A, type B, micro USB variants, and type C connections, for example, following the USB 1.0, 2.0, or 3.0 specifications. The power/data sender 408 can connect and transmit data and power through a multiline connection. The power/data sender 408 may communicate data through an optical data line such as a fiber optic cable.

The power/data sender 408 may not use a physical connection but may communicate data wirelessly including Wi-Fi based on the Institute of Electrical and Electronics Engineers (IEEE) 802.11 standard. The power/data sender 408 can communicate using standards such as Bluetooth, Bluetooth low energy, or the Wireless USB standard. The power/data sender 408 can send power wirelessly through capacitive coupling, inductive coupling, resonant inductive coupling, microwave transmission, laser transmission. For example, the power/data sender 408 may send power to a power receiver 104 using the open interface standard Qi developed by Wireless Power Consortium and Rezence developed by Alliance for Wireless Power, among others.

The thin client 102 can request data through the power/data sender 408. As discussed, data may flow from the server 206 to the NIC 208, and then may be sent to the thin client from the power/data sender 408. Data received at the data receiver 410 of the thin client 102 may be sent to the processor.

Power received at the power receiver 104 may be sent to the shutdown power source 106. As discussed, the power receiver 104 may be associated with a USB type C connector. The power receiver 104 may be a receiver for the other types of power transfer discussed above including a receiver for resonant inductive coupling energy transfer from the power/data sender 408 of the display device.

The thin client 102 can include a non-transitory, computer-readable storage media, such as a storage device 412 for the long-term storage of data, including the operating system programs and user file data. The storage device 412 can include local storage in a solid-state drive (SSD, a hard disk, or other non-volatile storage elements. While generally system information may be stored on the storage device 412, in this thin client 102, the program data can be stored in the memory 406. The storage device 412 may store instructions that may be executed by the processor 402 to perform a task. Applications and other data, up to and including the operating system for a zero client, can be accessed from the server, for example, through the NIC 208 in the display device 204.

The storage device 412 can include a power loss detector 414 to detect a power loss at a power receiver. The storage device 412 can include a shutdown sequence initializer 416 to activate, via a BIOS, a shutdown power source sized to store an amount of power for a shutdown sequence of the thin client. The shutdown sequence initializer 416 initializes, via a BIOS, a shutdown sequence powered by the shutdown power source in response to detection of a power loss condition at the power receiver.

Compiled operating systems may include code for a shutdown command that, when activated, may close and safely exit software and power down hardware. A shutdown sequence of a thin client may utilize a shutdown command of an operating system to perform shutdown operations on the thin client. Alternatively, a shutdown sequence may invoke a command to shut down an operating system and running applications using BIOS commands without invoking commands of the operating system. An operating system shutdown sequence may be activated by a specific type of shutdown command referred to as a force shutdown command. A force shutdown command may ignore exceptions or errors raised by applications during an exit and closing sequence. Operating systems and thin clients may power down as a result of a power-off button event. The thin client BIOS may simulate a power-off button event to initiate a shutdown sequence.

The shutdown power source may charge in response to a power receiving detection that the power receiver is receiving power. The shutdown power source 106 may recharge continuously while a power receiver 104 is receiving power. The shutdown power source 106 may recharge sporadically or at various time intervals, among other charge timings.

It is to be understood that the block diagram of FIG. 4 is not intended to indicate that the thin client 102 is to include all of the components shown in FIG. 4. Rather, the thin client 102 can include fewer or additional components not illustrated in FIG. 4.

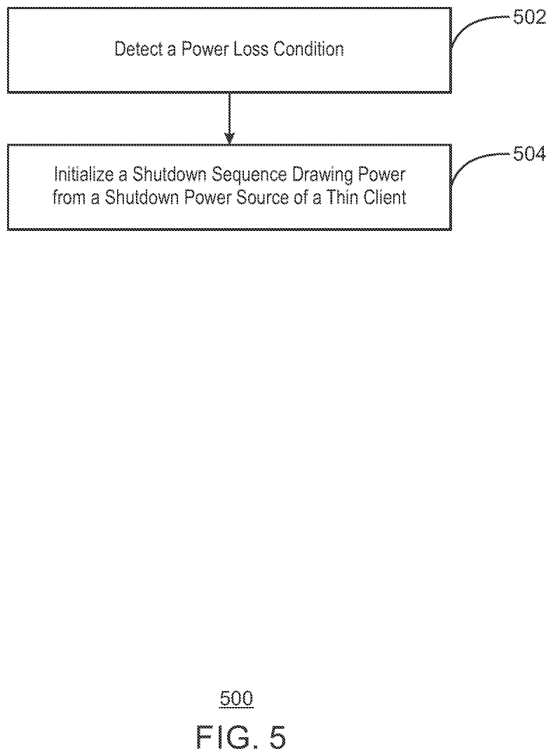

FIG. 5 is a flowchart of an example method 500 for a thin client. The method shown can be implemented on a thin client 102 of FIG. 4.

At block 502, a power loss condition is detected at a power receiver. At block 504, a shutdown sequence is initialized and draws power from a shutdown power source of a thin client in response to the detection of the power loss condition, where the shutdown power source is sized to store an amount of power for a shutdown sequence of the thin client.

The shutdown sequence may invoke an operating system shut down command. The shutdown sequence may invoke a command to shut down an operating system and running applications. The shutdown sequence may be activated by a force shutdown command issued by the BIOS. The shutdown sequence may be activated by a simulated power-off button event issued by the BIOS.

The shutdown power source may charge in response to a power receiving detection that the power receiver is receiving power. The method 500 may invoke, via the shutdown sequence, an operating system shut down command. The method 500 may invoke a command to shut down an operating system and running applications. The method 500 may activate, via the shutdown sequence by a force shutdown command issued by the BIOS.

It is to be understood that the block diagram of FIG. 5 is not intended to indicate that the method 500 is to include all of the actions shown in FIG. 5. Rather, the method 500 can include fewer or additional actions not illustrated in FIG. 5.

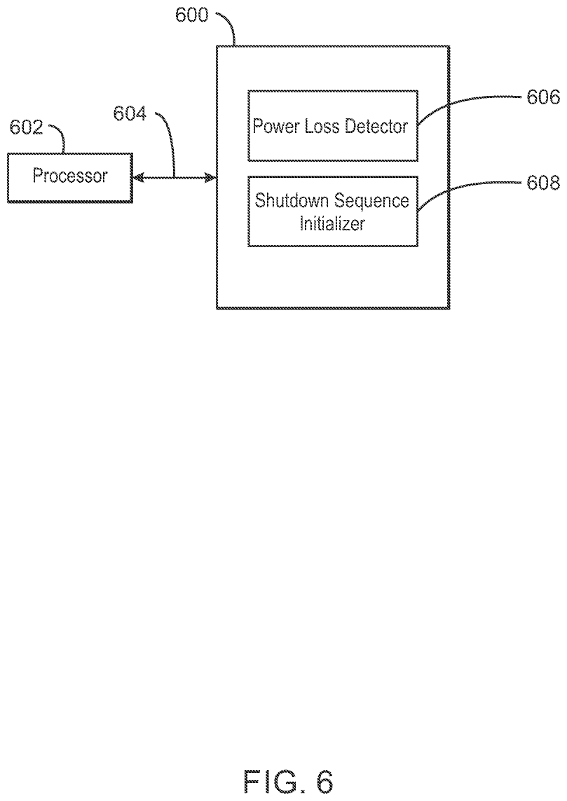

FIG. 6 is a block diagram of an example non-transitory, computer-readable medium 600 including instructions to direct a processor of a thin client. A processor 602 may execute instructions in the computer-readable medium 600. Instructions may be included to direct the processor 602 to activate a shutdown power source of a thin client over a bus 604. The bus 604 may be as described with respect to the bus 404 of FIG. 4.

The computer-readable medium 600 includes a power loss detector 606, to direct the processor 602 to detect a power loss of a thin client at a power receiver. The computer-readable medium 600 includes a shutdown sequence initializer 608 to direct the processor 602 to activate a shutdown power source and initialize a shutdown sequence of the thin client.

It is to be understood that the block diagram of FIG. 6 is not intended to indicate that the computer-readable medium 600 is to include all of the components shown in FIG. 6. Rather, the computer-readable medium 600 can include fewer or additional components not illustrated in FIG. 6.

While the present techniques may be susceptible to various modifications and alternative forms, the techniques discussed above have been shown by way of example. It is to be understood that the technique is not intended to be limited to the particular examples disclosed herein. Indeed, the present techniques include all alternatives, modifications, and equivalents falling within the scope of the following claims.

What is claimed is:

1. A thin client, comprising:
a power receiver;
a shutdown power source sized to store an amount of power for a shutdown sequence of the thin client; and
a basic input output system (BIOS) to initialize the shutdown sequence powered by the shutdown power source in response to detection of a power loss condition at the power receiver.

2. The thin client of claim 1, wherein the shutdown sequence is to invoke an operating system shut down command.

3. The thin client of claim 1, wherein the shutdown sequence is to invoke a command to shut down an operating system and running applications.

4. The thin client of claim 1, wherein the shutdown sequence is activated by a force shutdown command issued by the BIOS.

5. The thin client of claim 1, wherein the shutdown sequence is activated by a simulated power-off button event issued by the BIOS.

6. The thin client of claim 1, wherein the shutdown power source is to charge in response to a power receiving detection that the power receiver is receiving power.

7. The thin client of claim 1, wherein the power receiver is a universal serial bus type C connection.

8. The thin client of claim 1, comprising a mounting attachment to mount the thin client on a back of a display.

9. The thin client of claim 1, comprising:
a data channel; and
a case to encase the power receiver, shutdown power source, the data channel, and the BIOS where a sole port of the case connects to the data channel and the power receiver.

10. The thin client of claim 1, wherein the shutdown power source comprises a battery, or a capacitor, or both.

11. A method of shutdown in a thin client, comprising:
detecting a power loss condition at a power receiver; and
initializing a shutdown sequence drawing power from a shutdown power source of a thin client in response to the detection of the power loss condition, where the shutdown power source is sized to store an amount of power for a shutdown sequence of the thin client.

12. The method of claim 11, comprising invoking, via the shutdown sequence, an operating system shut down command.

13. The method of claim 11, comprising invoking a command to shut down an operating system and running applications.

14. A non-transitory, computer-readable medium comprising instructions that, in response to an execution by a processor:
detect a power loss condition at a power receiver, wherein the power receiver is a universal serial bus type C connection; and
initialize a shutdown sequence drawing power from a shutdown power source of a thin client in response to the detection of the power loss condition, where the shutdown power source is sized to store an amount of power for a shutdown sequence of the thin client.

15. The non-transitory, computer-readable medium of claim 14, comprising instructions that, in response to an execution by a processor execute a shutdown sequence in response to a power-off button event.
